(19) United States
(12) Patent Application Publication
(10) Pub. No.: US 2010/0313471 A1
(43) Pub. Date: Dec. 16, 2010

(54) SELF WATERING TREE STAND

(76) Inventor: Raymond Middaugh, Dingmans Ferry, PA (US)

Correspondence Address: STEVEN B. STEIN, 114 OLD BLOOMFIELD AVENUE, PARSIPPANY, NJ, 07054, US

(21) Appl. No.: 12/651,914

(22) Filed: Jan. 4, 2010

Related U.S. Application Data
(60) Provisional application No. 61/204,226, filed on Jan. 2, 2009.

(51) Int. Cl. A01G 23/00

(52) U.S. Cl. 47/40.5

(57) ABSTRACT

The present invention provides a self-watering tree stand comprising: (a) a tree stand body comprising (i) a base wall forming the bottom of the tree stand body; (ii) an inner body space reserve reservoir; (iii) an inner reservoir, situated entirely within the inner body reserve reservoir space; and (iv) a plurality of spaced, tree support members; (b) a liquid transfer means, capable of transferring liquid from the inner body space reserve reservoir to the inner reservoir; and (c) a liquid transfer means switch capable of activating and deactivating the liquid transfer means.

The present application claims priority to Provisional Application Ser. No. 61/204,226, filed Jan. 2, 2009, which is incorporated by reference in its entirety.

### FIELD OF THE INVENTION

The present invention relates generally to tree stands, and more particularly it relates to a self-watering tree stand. The self-watering tree stand of the present invention provides a tree stand and water reservoir as well as a reserve reservoir and means for automatically replenishing, aerating and refreshing the water reservoir.

### BACKGROUND OF THE INVENTION

Potted plants, and in particular, potted cut trees, including Christmas trees, require a continuous water source to maintain freshness of the tree, extend the life of the tree and reduce drying out of the tree. Typically, Christmas trees dry out over the course of days, causing leaves or needles to fall as well as creating a fire hazard. Keeping a typical tree stand filled with water is an arduous and imprecise task. In industrial settings, such as office complexes, maintenance of indoor trees requires scheduled watering and repeated maintenance. Merely having a tree sit in a basin of water is insufficient to maximally extend the life of the tree, whether a cut tree or live tree. While the prior art describes a variety of tree stands having reservoir or water basins or remote supplemental reservoirs, the present invention solves the described long-standing problem.

Attempts were made in the present field to address the issue of extending tree life by providing tree stands with a water basin, including stands with a remote reservoir. The prior arts closely related to the present invention include the following: U.S. Pat. No. 5,743,508, which discloses a tree stand with an inner water basin; U.S. Pat. Nos. 4,930,252 and 4,825,587 each of which disclose an apparatus for supplying water to a conventional tree stand using a form of remote reservoir. The present invention provides an integral, dual chamber approach to providing a self-contained, integrated, self-watering tree stand that provides appropriate water regulation and aeration to extend the life of the tree as well as to reduce the fire hazard of a drying tree.

In view of the foregoing disadvantages inherent in the above-described prior arts, the general purpose of the present invention is to provide an improved combination of convenience and utility, to include all the advantages of the prior arts, and overcome the abovementioned disadvantages and drawbacks of the prior arts.

These together with other objects of the invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying Summary, Drawings and Descriptive Description of the Invention in which there are illustrated exemplary embodiments of the invention.

### SUMMARY OF THE INVENTION

The present invention provides a self-watering tree stand comprising: (a) a tree stand body comprising (i) a base wall forming the bottom of the tree stand body; (ii) at least one outer body sidewall having a top end, a bottom end, a left side and a right side, wherein the outer body sidewall bottom end is sealed and attached to the base wall and the left side of a first outer body sidewall is attached and sealed to the right side of a second outer body sidewall, circumscribing the perimeter of the base wall, thereby defining an inner body reserve reservoir space; (iii) an inner reservoir, wherein the inner reservoir is situated entirely within the inner body reserve reservoir space and is defined by an inner body side wall, wherein the inner body sidewall is having a top end, a bottom end, a left side and a right side, wherein the inner body sidewall bottom end is sealed and attached to the base wall and the left side of a first inner body sidewall is attached and sealed to the right side of a second inner body sidewall, circumscribing the perimeter of the inner reservoir space distinct from the inner body reserve reservoir space; and (iv) a plurality of spaced, tree support members having inner surfaces, wherein the members are secured to the base wall in a substantially upright position and having a length greater than a height of the outer body side wall and wherein each tree support member includes an elongated, radially oriented channel extending through the member adjacent its distal end for containing a securing arm; (b) a liquid transfer means, capable of transferring liquid from the inner body reserve reservoir space to the inner reservoir; and (c) a liquid transfer means switch capable of activating and deactivating the liquid transfer means.

### BRIEF DESCRIPTION OF THE DRAWINGS

FIG. 1 is a perspective view of a preferred embodiment of the present invention.

FIG. 2 is a bottom partial cutaway view of the present invention.

FIGS. 3A-3B show top section views of the present invention.

FIGS. 4A-4B FIG. 4A shows a side cross section view and FIG. 4B shows a cross sectional, elevation view of the present invention showing the pump and float switch of the preferred embodiment.

Like reference numerals refer to like parts throughout the several views of the drawings.

### DETAILED DESCRIPTION OF THE INVENTION

The present invention provides a self-watering tree stand comprising: (a) a tree stand body comprising (i) a base wall forming the bottom of the tree stand body; (ii) at least one outer body sidewall having a top end, a bottom end, a left side and a right side, wherein the outer body sidewall bottom end is sealed and attached to the base wall and the left side of a first outer body sidewall is attached and sealed to the right side of a second outer body sidewall, circumscribing the perimeter of the base wall, thereby defining an inner body reserve reservoir space; (iii) an inner reservoir, wherein the inner reservoir is situated entirely within the inner body reserve reservoir space and is defined by an inner body side wall, wherein the inner body sidewall is having a top end, a bottom end, a left side and a right side, wherein the inner body sidewall bottom end is sealed and attached to the base wall and the left side of a first inner body sidewall is attached and sealed to the right side of a second inner body sidewall, circumscribing the perimeter of the inner reservoir space distinct from the inner body reserve reservoir space; and (iv) a plurality of spaced, tree support members having inner surfaces, wherein the members are secured to the base wall in a substantially upright position and having a length greater than a height of the outer body side wall and wherein each tree support member includes an elongated, radially oriented channel extending through the member adjacent its distal end for containing a securing arm; (b) a liquid transfer means, capable of transferring liquid from the inner body reserve reservoir space to the inner reservoir; and (c) a liquid transfer means switch capable of activating and deactivating the liquid transfer means.

According to one embodiment of the present invention, the bottom of the tree stand is slightly elevated above the floor level, thereby reducing transmission of condensation from the bottom of the stand to a floor surface beneath the stand. It is recognized that the increased volume of water in the dual reservoir provides increased stability to the tree stand. According to a preferred embodiment, the capacity of the reservoirs is about approximately three gallons.

According to a preferred embodiment of the present invention, the outer body side wall of the tree stand body is formed from a single piece of material. It is contemplated by the present invention that the outer body side wall may be comprised of a plurality of outer body side wall segments, which in aggregate form the entirety of the outer body side wall. It is further contemplated that where a plurality of outer body side wall segments is used, the segments must be joined and sealed in a water tight fashion such as is known in the art. According to one embodiment, water tight sealant is used in joining the segments. According to another embodiment, gaskets are used in joining the segments. It is also contemplated that the tree stand body may be made of a variety of water tight materials including plastic, metal, fiberglass, composite, wood, rubber, vinyl and the like. According to a preferred embodiment, the tree stand body is made from molded plastic. According to a most preferred embodiment, the tree stand body is formed from a single piece of material.

According to one embodiment of the present invention, the liquid transfer means is a pump. Pumps are well known in the art for moving liquid from one place to another. According to a preferred embodiment of this invention, the pump is a submersible pump. According to an alternative embodiment of this invention, the liquid transfer means is a pressurized water supply line. Gravity driven supply is also contemplated. The present invention further contemplates that where numerous tree stands are in use or where live trees are to be maintained for long periods, a continuous supply of fresh water is desirable. Accordingly, this alternative embodiment provides a pressurized water supply line attachable to a building or municipal or private water supply system. According to another alternative embodiment, the tree stand is further comprising an electric valve attached to the liquid transfer means, thereby regulating the transfer of liquid from the inner body reserve reservoir to the inner reservoir. A preferred embodiment of the present invention provides a pump with an electric power source. It is well understood in the art that the power source can be electricity provided by the local power grid, a generator, a solar cell, a capacitor or a battery.

According to still another embodiment of the present invention, the liquid transfer means switch is activated by the water level in the water basin. According to one embodiment of this invention, a pump is activated by a simple switch. According to another embodiment, the switch is a microswitch. According to a preferred embodiment, the switch is a float switch that is activated when the water level reaches a minimum low level and deactivated when the water level is filled to a desired high level. The present invention considers that a live tree consumes substantial amounts of water from the inner reservoir, thereby depleting the water in the reservoir over time. According to a most preferred embodiment, the float switch is adjustable. According to still another embodiment of this invention, the switch is programmable. According to still another embodiment the switch is remote controlled. Such remote controlled switching is well known in the art and operable by remote transmission of such signals as radio frequency (RFID); bluetooth (BT); infrared (IF) and other like methods, which require a paired receiver and transmitter. According to still another alternative embodiment, the switch further comprises a “low level” indicator, which may be in the form of a light, sound or other signal indicating that the water level is low. According to the preferred embodiment of the invention, the switch indicates that the level in the inner reservoir is low. According to another alternative embodiment of this invention a second float indicator device is provided indicating that the inner body reserve reservoir space water level is low. According to this alternative embodiment, the second float “low level” indicator may be in the form of a light, sound or other signal indicating that the water level in the inner body reserve reservoir space is low.

According to another embodiment of the present invention, the provided tree stand is further comprising a channel situated between the inner reservoir and the inner body space reserve reservoir.

According to a preferred embodiment, the pump is positioned within one of the provided tree stand support stands. According to yet another preferred embodiment, the provided tree stand is further comprising a water filler pipe having an open top end and a bottom end, wherein the open top end is accessible from outside the tree stand and wherein the bottom end opens into the inner body reserve reservoir. This preferred embodiment facilitates the filling of the inner body reserve reservoir particularly when a tree is positioned within the tree stand and the branches make filling the reservoirs difficult. It is contemplated that the water filler pipe can extend beyond the walls of the tree stand according to one embodiment, while it is also contemplated that the water filler pipe can be approximate with the height of the tree stand according to another embodiment. According to still another embodiment, the water filler pipe further comprises a filler pipe cap, which is removable. The present invention contemplates that the pipe cap may be a screw type cap, a snap type cap, a cork like cap or any other cap known in the art. According to one preferred embodiment, the water filler pipe further comprises channels formed in each side of the filler pipe, which thereby facilitate cap removal and insertion. According to another preferred embodiment of this invention, the corresponding filler pipe cap has side tabs that insertably match the water filler pipe channels. According to still another embodiment, the cap further comprises an aperture capable of transmitting air pressure therethrough, thereby venting any built up gas or releasing any vacuum formed in the reservoir, which might interfere with operation of the liquid transfer means.

According to still yet another embodiment of the present invention, the tree stand is further comprising a reservoir sight glass means capable of indicating the water level in the inner body space reserve reservoir. Sight glass means for determining fluid level is well known in the art and numerous methods are contemplated by the present invention. According to a preferred embodiment, the sight glass means is a ball float type indicator.

Finally, according to yet still another embodiment, the present invention provides that the tree stand further comprises an aerator capable of aerating the water in the inner reservoir. Aerators are well known in the art. It is also well known that increased aeration facilitates plant life.

The exemplary embodiments described herein detail for illustrative purposes are subject to many variations in structure and design. It should be emphasized, however that the present invention is not limited to a particular embodiment shown and described. Rather, the principles of the present invention can be used with a variety of configurations and structural arrangements. It is understood that various omissions, substitutions of equivalents are contemplated as circumstances may suggest or render expedient, but is intended to cover the application or implementation without departing from the spirit or scope of the claims of the present invention.

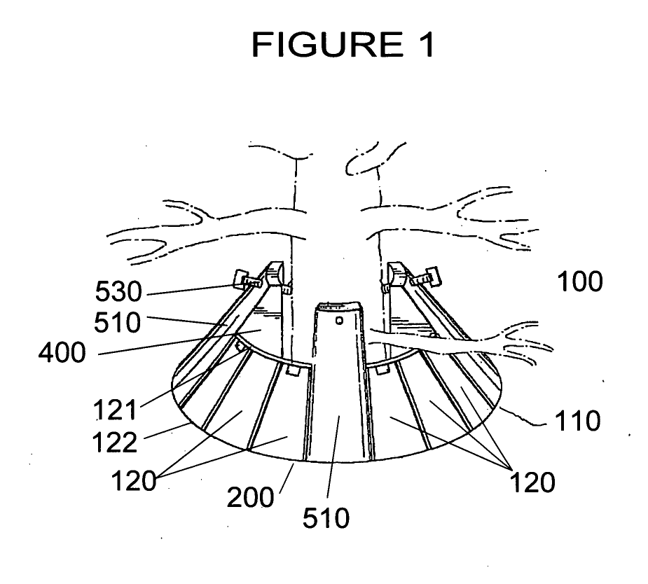

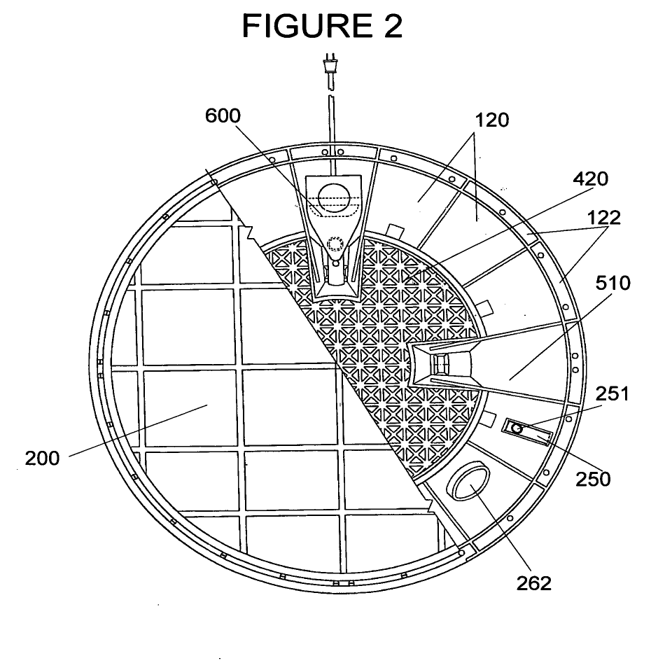

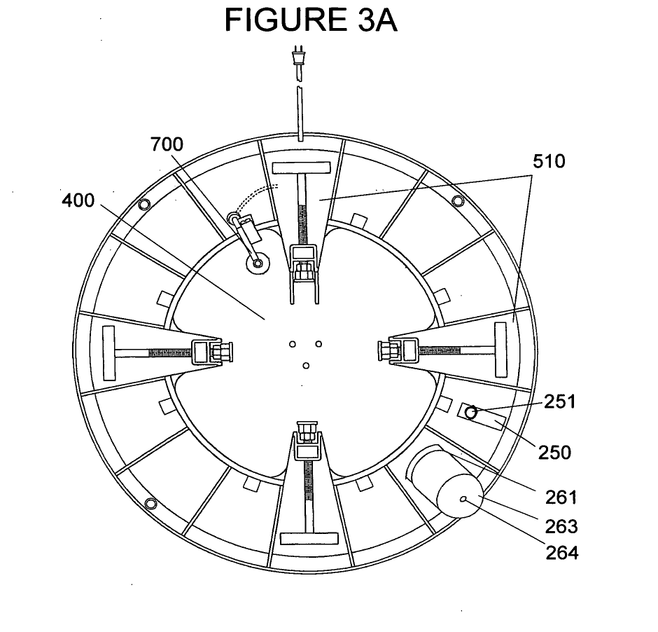

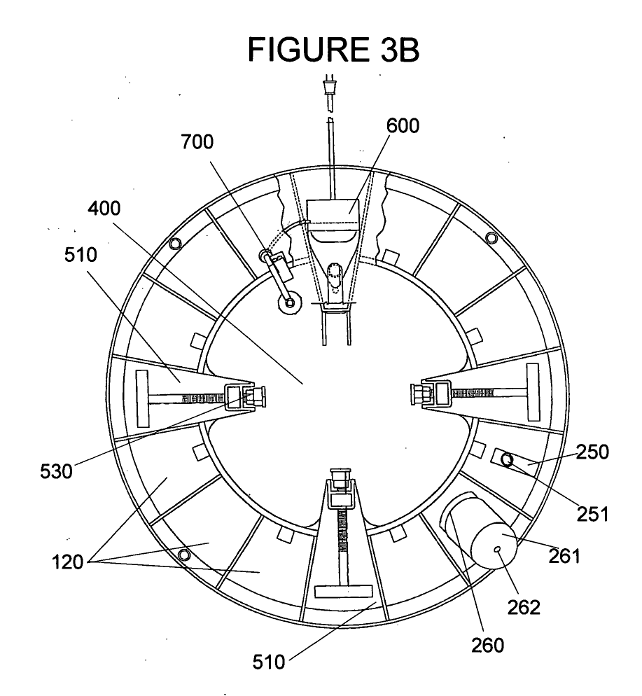

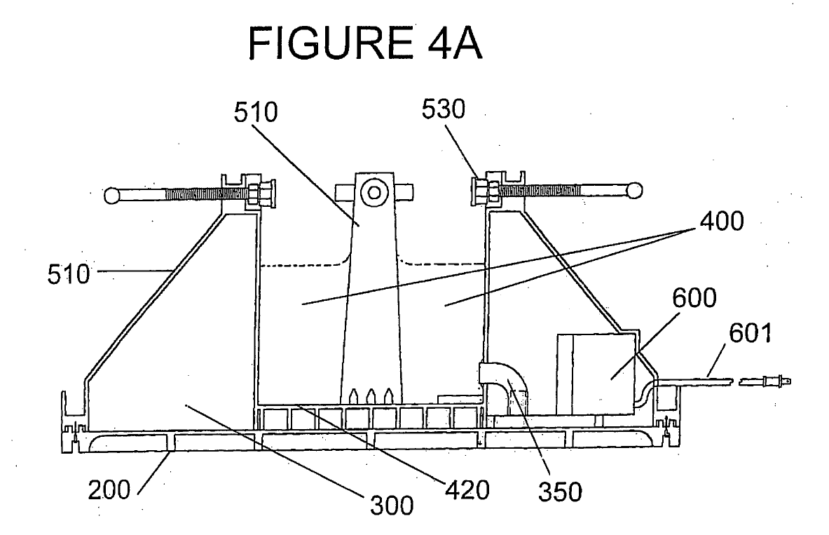

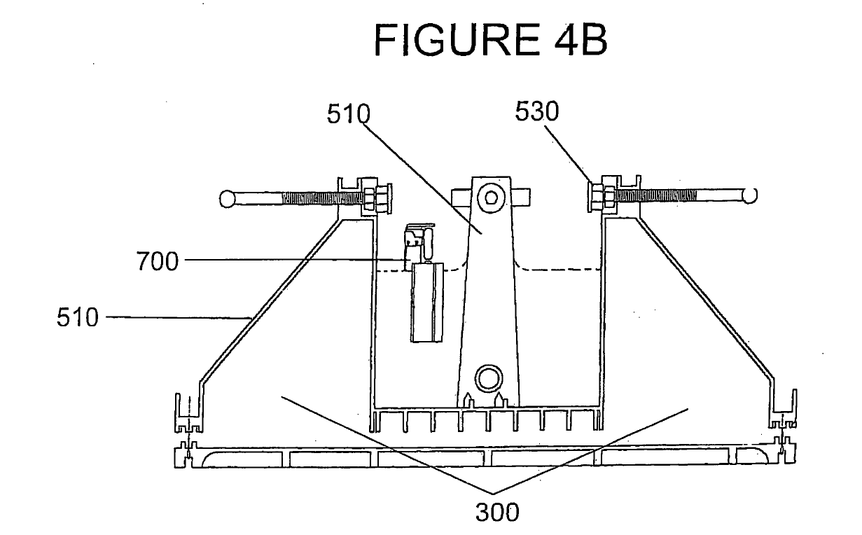

Turning now to the figures, FIG. 1 shows a perspective view of the tree stand, illustratively showing the trunk of a tree situated in the tree stand 100. The illustrative tree trunk is situated within the inner reservoir space 400 and is held in place by tree support members 510 and adjusted for fit securing adjustment arms 530. FIG. 2 shows a bottom partial cutaway view of the present invention. FIGS. 3A and 3B show top section views of the present invention with illustrative embodiments. FIGS. 4A and 4B show side cross section views of the present invention with illustrative embodiments.

FIGS. 2, 3A and 3B show top and bottom views of the tree stand body 110, which comprises a base wall 200 forming the bottom of the tree stand body 110; at least one outer body sidewall 120 having a top end 121, a bottom end 122, a left side 123 and a right side 124, wherein the outer body sidewall bottom end 122 is sealed and attached to the base wall 200 and the first outer body sidewall left side 123 is attached and sealed to the second outer body sidewall right side 124, circumscribing the perimeter of the base wall 200, thereby defining an inner body reserve reservoir space 300. A sight glass 250 is shown with a floating ball 251, which facilitates visualization of the water level in the inner reservoir reserve space 300. Also shown is a water filler pipe 260, which is used to replenish water in the inner reservoir reserve space 300. The water filler pipe has a top end 261 where water is introduced into the tree stand body 110 and a bottom end 262 where water drains into the inner reservoir reserve space 300. A water filler pipe cap 263 is also provided. A water filler pipe cap aperture 264 permits the transmission of gas pressure to avoid formation of pressure or vacuum.

FIGS. 4A and 4B show cross sectional views, which illustrate the inner reservoir 400, which is situated entirely within the inner body reserve reservoir space 300 and is defined by an inner body side wall 420, wherein the inner body sidewall is having a top end 421, a bottom end 422, a left side 423 and a right side 424, wherein the inner body sidewall bottom end 422 is sealed and attached to the base wall 200 and a first inner body sidewall left 423 is attached and sealed to a second inner body sidewall right side 424, circumscribing the perimeter of the inner reservoir space 400 distinct from the inner body reserve reservoir space 300. According to another alternative embodiment of the invention, the inner body reserve reservoir space further comprises an inner reservoir space base wall 420. A plurality of spaced, tree support members 510 having inner surfaces 511, wherein the support members 510 are secured to the base wall 220 in a substantially upright position and having a length greater than a height of the outer body side wall 120 and wherein each tree support member 510 includes an elongated, radially oriented channel 520 extending through the support member 510 adjacent its distal end for containing a securing arm 530.

FIGS. 4A and 4B also show the submersible pump 600, together with electric supply cord 601, the pump being controlled by a float switch 700. The pump is capable of transferring liquid from the inner body reserve reservoir space 300 to the inner reservoir 400 via a closed channel 350 situated between the inner reservoir and the inner body space reserve reservoir.

A liquid transfer means, illustratively shown as a float switch 700 capable of activating and deactivating the pump 600 is shown.

Many modifications and variations of the present invention are possible in light of the above teachings. It is therefore to be understood that within the scope of the appended claims, the invention may be practiced otherwise then as specifically described. The preferred embodiments described herein detail for illustrative purposes are subject to many variations in structure and design. It should be emphasized, however, that the present invention is not limited to the particular embodiments shown and described. Rather, the principles of the present invention can be used with a variety of configurations and structural arrangements. It is understood that various omissions, substitutions of equivalents are contemplated as circumstance may suggest or render expedient, but is intended to cover the application or implementation without departing from the spirit or scope of the claims of the present invention.

Indeed, this invention may be embodied in other forms or carried out in other ways without departing from the spirit or essential characteristics thereof. The present disclosure is therefore to be considered as in all respects illustrative and not restrictive, the scope of the invention being indicated by the appended Claims, and all changes which come within the meaning and range of equivalency are intended to be embraced therein.

What is claimed is:

1. A self-watering tree stand comprising:
a. Tree Stand body comprising:
i. a base wall forming the bottom of the tree stand body;
ii. at least one outer body sidewall having a top end, a bottom end, a left side and a right side, wherein the outer body sidewall bottom end is sealed and attached to the base wall and the left side of a first outer body sidewall is attached and sealed to the right side of a second outer body sidewall, circumscribing the perimeter of the base wall, thereby defining an inner body reserve reservoir space;
iii. an inner reservoir, wherein the inner reservoir is situated entirely within the inner body reserve reservoir space and is defined by an inner body side wall, wherein the inner body sidewall is having a top end, a bottom end, a left side and a right side, wherein the inner body sidewall bottom end is sealed and attached to the base wall and the left side of a first inner body sidewall is attached and sealed to the right side of a second inner body sidewall, circumscribing the perimeter of the inner reservoir space distinct from the inner body reserve reservoir space;
iv. a plurality of spaced, tree support members having inner surfaces, wherein the members are secured to the base wall in a substantially upright position and having a length greater than a height of the outer body side wall and wherein each tree support member includes an elongated, radially oriented channel extending through the member adjacent its distal end for containing a securing arm;
b. A liquid transfer means, capable of transferring liquid from the inner body reserve reservoir space to the inner reservoir;
c. A liquid transfer means switch capable of activating and deactivating the liquid transfer means.

2. The tree stand according to claim 1, wherein the outer sidewall is formed from a single piece of material.

3. The tree stand according to claim 1, wherein the inner sidewall is formed from a single piece of material.

4. The tree stand according to claim 1, wherein the liquid transfer means is a pump.

5. The tree stand according to claim 1, wherein the liquid transfer means is a pressurized water supply line.

6. The tree stand according to claim 1, wherein the pump power source is electric.

7. The tree stand according to claim 2, wherein the pump power source is a battery.

8. The tree stand according to claim 1, wherein the liquid transfer means switch is activated by the water level in the water basin.

9. The tree stand according to claim 1, where the liquid transfer means switch is adjustable.

10. The tree stand according to claim 1, wherein the liquid transfer switch is a float switch.

11. The tree stand according to claim 1, wherein the pump is a submersible pump.

12. The tree stand according to claim 1, further comprising a channel situated between the inner reservoir and the inner body space reserve reservoir.

13. The tree stand according to claim 1, wherein the pump is positioned within one of the support stands.

14. The tree stand according to claim 1, further comprising a water filler pipe having an open top end and a bottom end, wherein the open top end is accessible from outside the tree stand and wherein the bottom end opens into the inner body reserve reservoir.

15. The tree stand according to claim 11, further comprising a filler pipe cap removably connected to the open top end of the filler pipe.

16. The tree stand according to claim 1, further comprising a reservoir sight glass means capable of indicating the water level in the inner body space reserve reservoir

17. The tree stand according to claim 1, further comprising an electric valve attached to the liquid transfer means.

18. The tree stand according to claim 1, wherein the liquid transfer means switch is programmable.

19. The tree stand according to claim 1, further comprising an aerator.
